(19) United States
(12) Patent Application Publication
(10) Pub. No.: US 2008/0010846 A1
(43) Pub. Date: Jan. 17, 2008

(54) Spacing tool

(76) Inventor: John Frederick Bingham, Newtown, CT (US)

Correspondence Address: JOHN F. BINGHAM, 16 MOUNT NEBO ROAD, NEWTOWN, CT, 06470, US

(21) Appl. No.: 11/485,874

(22) Filed: Jul. 13, 2006

(51) Int. Cl. G01D 21/00

(52) U.S. Cl. 33/613

(57) ABSTRACT

A hand tool (10) includes a generally planar body (12) having a thickness approximately equal to a predetermined desired spacing between two objects such as deck boards, a flange (16) having a contact surface generally perpendicular to the planar body, and a handle (14) extending from the flange in a direction away from the planar body. In use, the planar body is inserted between two boards while one or both boards are fastened to a substructure. The tool is removed by grasping the handle and either pulling it out or rocking it so that a portion of the flange acts like a fulcrum to pivot the planar body out of the space between the two boards.

### RELATED APPLICATIONS

This application claims priority from U.S. Provisional Application 60/698,373, which was filed on Jul. 12, 2005.

### TECHNICAL FIELD

The present invention relates to hand tools and, more particularly, to hand tools used for assisting a technician in maintaining alignment of two objects while one or both are fastened to a third object such as, for example, deck boards.

### BACKGROUND OF THE INVENTION

Various building and repair procedures require assembly of two objects to a third object wherein the first two objects require predetermined spacing and alignment. For example, in building a deck or platform consisting of elongated boards or sections fastened to a substructure, it is necessary to align the boards in parallel with equal spacing.

Known hand tools to assist in such procedures include generally flat objects that are positioned between the boards, sometimes at spaced intervals, to maintain the spacing and alignment. A common shortcoming of such devices is the inability to easily remove them when compressive forces between the two boards applied to the device squeeze the device with a level of force that makes it difficult for a user to remove by simply grasping and pulling.

### OBJECTS OF THE PRESENT INVENTION

It is an object of the present invention to provide a hand tool for assisting in maintaining alignment of two objects while one or both are fastened to a third object that overcomes the shortcomings of known devices as described above. It is a further object to provide a hand tool of the type mentioned above that is efficient, durable, and easy to use. These and other objects are achieved by the present invention.

### SUMMARY OF THE PRESENT INVENTION

A hand tool according to the present invention includes a generally planar body having a thickness approximately equal to a predetermined desired spacing between two objects such as deck boards, a flange having a contact surface generally perpendicular to the planar body, and a handle extending from the flange in a direction away from the planar body. In use, the planar body is inserted between two boards while one or both boards are fastened to a substructure. The tool is removed by grasping the handle and either pulling it out or rocking it so that a portion of the flange acts like a fulcrum to pivot the planar body out of the space between the two boards.

### BRIEF DESCRIPTION OF THE DRAWINGS

FIG. 1 is a side view of the presently claimed invention.

FIG. 2 is a front view of the presently claimed invention.

FIG. 3 is a top view of the presently claimed invention.

### DESCRIPTION OF THE PREFERRED EMBODIMENTS

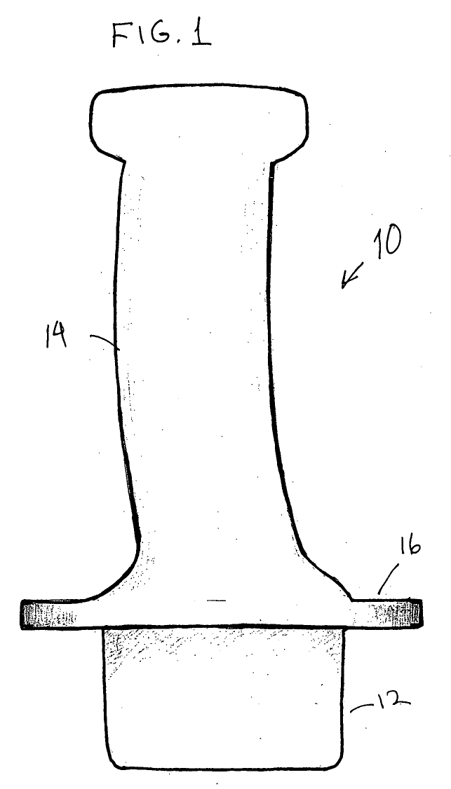

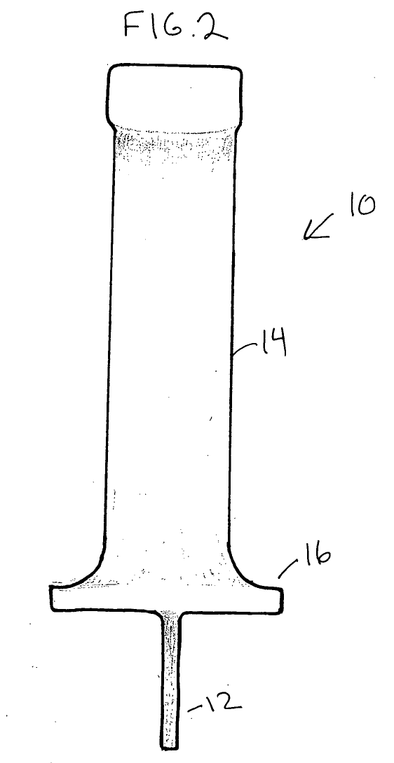

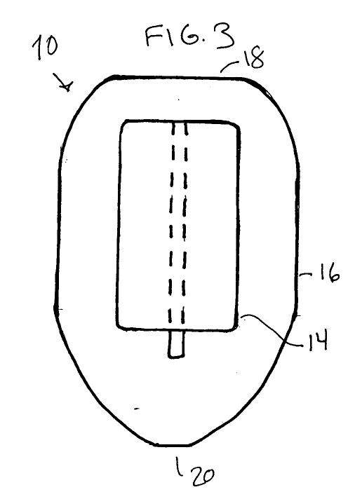

A hand tool according to the present invention is described herein with respect to FIGS. 1-3. A tool (10) includes a generally planar body (12) attached to a handle (14) having a flange (16) positioned at the end of the handle (14) closest to the planar body (12). The tool (10) may be of uniform construction or of multiple, assembled parts. The tool (10) may be made of high impact plastic, metal, wood, other known materials, or a combination thereof. It may be molded or machined.

The blade (12) has a thickness that is approximately equal to a desired, predetermined spacing that will be used between two objects to be assembled to a third object such as, for example, to deck boards being fastened to a substructure. The present invention is not limited to deck board construction and it has many potential uses. For illustrative purposes, the description herein will refer to deck boards as an example. The blade (12) should be of sufficient length to extend vertically between the boards sufficiently to maintain them in desired spacing. Multiple tools (10) can be used when it is desired to assure parallel alignment of the boards. The bottom edge of the planar body (12) may be flat so as to rest in an upright position upon contact with a substructure.

The handle (14) is of sufficient length to be grasped by a user's hand for insertion or removal between boards. Preferably the handle (14) has a curved contour as shown in FIG. 1, though it may be of any shape suitable for grasping and it may include handgrip contours. The uppermost end of the handle (14) may have a lip as shown in FIG. 1 to prevent slippage. The flange (16) is wide enough to span the predetermined space between boards so that only the planar body (12) will fit in the space. First and second ends of the flange (18, 20) may be shaped to assist in other functions. For example, the first end (18) is generally flat in profile and can assist a user in removing the tool (10) from a tight space if the planar body (12) is squeezed tightly. This is achieved by grasping the handle (14) and-rocking the tool (10) on the first end (18) so that the first end (18) acts as a fulcrum to rotate the planar body (12) out of the board space.

Optionally, orie or more nails (not shown) can be driven through the flange either directly or through pre drilled holes (not shown) into a board to hold the tool (10) in position relative to the board. Alternatively, one or more permanent nail-like spikes can be permanently mounted to extend from the bottom of the flange.

While the present invention is shown and described herein, various modification can be made without departing from the scope of the invention.

What is claimed is:

1) A spacing tool for maintaining a predetermined space between two objects during a process in which one or both objects are fastened to a third object, said tool comprising
a generally planar body having a thickness approximately equal to the length of said predetermined space between said two objects;
a flange having a contact surface approximately perpendicular to said body; and
a handle extending from said flange in a direction away from said body and generally parallel to said body.

2) A tool according to claim 1, further comprising
a first fulcrum section of said flange for pivotally rocking said tool onto said first fulcrum to remove said tool from between said two objects.

3) A tool according to claim 3, further comprising
a second fulcrum section of said flange for pivotally rocking said tool onto said second fulcrum to remove said tool from between said two objects.

4) A tool according to claim 1, wherein said handle has a length that is sufficient to span the width of a user's hand while it is grasped by said user's hand.

5) A spacing tool for maintaining a predetermined space between two boards during a process in which one or both boards are fastened to a third object, said tool comprising
a generally planar body having a thickness approximately equal to the length of said predetermined space between said two boards;
a flange having a contact surface approximately perpendicular to said body; and
a handle extending from said flange in a direction away from said body and generally parallel to said body.

6) A tool according to claim 5, further comprising
a first fulcrum section of said flange for pivotally rocking said tool onto said first fulcrum to remove said tool from between said two boards.

7) A tool according to claim 6, further comprising
a second fulcrum section of said flange for pivotally rocking said tool onto said second fulcrum to remove said tool from between said two boards.

8) A tool according to claim 5, wherein
said handle has a generally curved shape within a plane generally parallel to said body.

9) A tool according to claim 5, wherein
said tool is a unitary body.

10) A tool according to claim 5, wherein
said tool is plastic.
